(19) United States
(12) Patent Application Publication
(10) Pub. No.: US 2003/0043974 A1
(43) Pub. Date: Mar. 6, 2003

(54) Stored profile system for storing and exchanging user communications profiles to integrate the internet with the public switched telephone network

(76) Inventor: Harry E. Emerson III, Succasunna, NJ (US)

Correspondence Address: Ernest D. Buff, Ernest D. Buff & Associates, LLC, 245 South Street, Morristown, NJ, 07960, US

(21) Appl. No.: 10/228,723

(22) Filed: Aug. 27, 2002

Related U.S. Application Data
(60) Provisional application No. 60/317,057, filed on Sep. 4, 2001.

(51) Int. Cl. H04M 11/00; H04M 1/64

(52) U.S. Cl. 379/88.13; 379/88.17

(57) ABSTRACT

A stored profile system has a method and means for storing and exchanging user profiles of communications-related information for voice and multimedia communications on the PSTN and the Internet. Stored profile exchanges from a called party device to a calling user enables the calling user to direct the call to telephone numbers and services presented by the called party's profile. Users are enabled to transmit information, such as an Electronic Business Card, in the call setup process for display on a receiving device. The stored profile system operates across the Public Switched Telephone Network (PSTN) and the Internet, further enhancing the benefits of integrating the Internet with the PSTN.

This application claims the benefit of U.S. Provisional Application No. 60/317,057, filed Sep. 4, 2001.

### BACKGROUND OF THE INVENTION

1. Field of the Invention

The present invention relates to the Internet and the Public Switched Telephone Network (PSTN); and more particularly to the integration of the Internet with the PSTN in a manner such that systems, services, and devices on either can communicate with systems, services, and devices on the other, so that the full benefit and unique characteristics of either network are available to these communications.

2. Description of the Prior Art

The Internet and the PSTN constitute discrete, independent networks from an architectural and operational perspective. Much is written about both networks, especially in terms of their architecture and operation. Consequently, the specification provided herein does not reconstruct that information, but instead is directed to a skilled worker knowledgeable in such matters. The term “Internet” is commonly understood and used throughout the specification and claims in a conventional way. The Internet, in general, is an assemblage of interconnected routers that provide data transport services for server computers and user devices—typically PCs. The interconnection between routers is provided by private line data circuits, the main lines of which constitutes the Internet “backbone”. Internet Service Providers (ISPs) provide access to the Internet via dial up telephone lines with modems, and via dedicated arrangements such as T-1 circuits, cable modems on cable-TV systems, and DSL (Digital Subscriber Line) service.

The Internet is designed according to the Internet Protocol (IP), which provides detailed specifications for the construction, addressing, and routing of data packets (occasionally referred to as “messages” in this document). (The term “Internet Protocol” also is used loosely to refer to dozens of related protocols that are used in the Internet.) IP addresses are expressed as a series of digits separated by “dots” (periods), in the form XXX.XXX.XXX.XXX where XXX can be a number from 0 to 255. IP addresses provide a similar function on the Internet as telephone numbers provide on the PSTN. A communication with an Internet device can be established by sending a message addressed to the IP address of that device. Every device capable of communicating on the Internet has an IP address assigned to it, either permanently, or dynamically as needed. IP addresses in some environments are replaced with a proxy address; for purposes of this document, the term “IP address” shall refer to an actual IP address, or a proxy or other identifier translatable into an actual IP address. In some of these arrangements, the IP address may be indirectly associated with the device. For example, in a wireless handset arrangement, the provider's complex might provide Internet connections for wireless handsets on a proxy basis wherein the complex keeps track of IP number assignments used for each handset, but communicates with each handset based on a serial number or other unique identifying scheme. The same goal is accomplished, i.e. an Internet capable handset gets its own IP address, but with one level of indirection. In other arrangements proxies or agents act on behalf of a client system and substitute the proxy's IP addresses for the addresses of the client devices—in these arrangements the combination of the proxy address and the original client system address resolve to provide a unique IP address for each client system. Internet data packets contain the IP address of both the sending system and receiving system (the source and destination, respectively). Since IP messages always contain the IP addresses of both the sending and destination device, when a device receives an Internet message from a sending device, it will then possess the IP address of the sender and can send messages in reply. The two devices can then engage in a communication across the Internet since each has the IP address of the other.

Routers have internal tables that provide routing instructions, which relate IP addresses to the available data circuits and access lines. A router functions by reading the destination address in a data packet, and then forwarding the data packet on one of its data circuits or access lines according to the rules of the routing tables. A data packet gets forwarded from one router to another, pinballing its way across the Internet until it reaches a router that is connected to the destination system.

The term “Public Switched Telephone Network”, or PSTN, as used herein means the national and international telephone network, actuated when a user dials a telephone number associated with any other phone, causes it to ring, and if answered, is enabled to carry on a voice communication (or, more properly, a “voice grade” communication) with the person (or system) at the remote location. Just as the Internet is comprised of an aggregation of interconnected routers, the PSTN is comprised of an aggregation of interconnected local and long distance telephone switching systems. The local switching systems, referred to as telephone company (telco) central offices (CO), provide telephone subscriber services in a geographic area.

As used herein, the term “telephone central office switching system” refers generically to a class of systems, typically owned by the operating telephone company in any given area, which provide “local” telephony services to telephone subscribers in that area. Generally, the operating telephone company provides the “local loop” cabling and wiring from its central office to the physical location of each of its subscribers (a “telephone circuit”, or a “line”). A telephone central office might house several switching systems of this class, each serving up to 100,000 subscribers or more. The central office represents the hub of a wheel having thousands of spokes, each spoke being a physical pair of wires providing telephone service to a subscriber in that area. Subscribers in any given area are provided service by the central office situated in the center of the area. Outside that area the wires home to other similarly situated central offices. The telephone company connects the telephone circuit of a subscriber to an access connection on the switching system, and assigns a telephone number to that circuit. In operation, the switching system (or just “switch”) provides battery voltage on the phone line, sends dial tone to the subscriber line when the subscriber's phone goes off hook, receives the dialed digits, and then routes the call according to its internal instructions based on the called number.

Common manufactured switching systems of this class include the Lucent Technologies 5ESS, and the Nortel DMS100. All telephone central office-switching systems around the world are interconnected by “trunk” circuits that carry voice or voice grade telephone calls between systems, and most (if not all) such systems are also interconnected by a messaging network referred to as CCS/SS7 (Common Channel Signaling/Signaling System 7), or just SS7. Long distance calls to telephones outside of the area served by the local telephone company are typically routed to a long distance carrier, such as AT&T, MCI, or Sprint in the USA. The telephone central office switches connect via trunking and messaging circuits to a class of switching system referred to as a “toll switch”, such as the Lucent Technologies 4ESS, operated by a long distance carrier. Toll switches normally do not provide local telephone services.

In the current state of the art there are two inter-related messaging systems utilized within the PSTN. These are: (i) CCS/SS7 (Common Channel Signaling/Signaling System 7, commonly referred to as just “SS7”); and (ii) ISDN (Integrated Services Digital Network), which incorporates a messaging system as an element of a broader product and service architecture. The SS7 messaging system extends through the major elements and systems of the PSTN, connecting virtually all of the local and long distance central offices, and carries call management messages relating to call setup and disconnection and similar call management functions. Whereas the SS7 messaging system is oriented toward providing messaging communications among and between the PSTN switching systems, the ISDN messaging system is oriented toward extending the PSTN messaging system to the end devices such as telephones and office telephone systems. Rather than going off hook and drawing dial tone from the local central office switching system to initiate a call, as analog phones do, an ISDN phone sends a packetized message to the switching system to initiate a call. Both the ISDN messaging system and the SS7 messaging system are based on the X.25/X.75 communications protocols. ISDN messages are carried on the SS7 messaging network. Disadvantageously, neither the SS7 nor the ISDN messaging systems carry any messages related to Internet communications.

Conventional communication vehicles comprise computers and telephones. Computers typically have telephone lines attached to them, and telephones oftentimes have computers attached to them; but there is no true integration that enables the blending of the Internet and the PSTN. The level of integration that is presently attained permits a computer to use a phone line to dial into the Internet. Once on the Internet, the computer can access another computer by entering its Internet Protocol (IP) address into application software such as a browser.

In an associated matter, there are now a variety of technologies that provide both Internet and PSTN connectivity. These technologies include: (i) VoIP service (ii) DSL service; (iii) cable modem service delivered by cable-TV systems; (iv) fixed wireless systems; and (v) Internet capable cellular wireless systems. The following provides a brief review of these technologies.

In one aspect, the systems described herein relate to Voice over IP service. The term IP refers to the “Internet Protocol”, the basic protocol of the Internet, while the term Voice over IP refers to sending digitized voice across the Internet using the IP protocol. Several companies provide discount rate phone calls using “Voice over IP” (VoIP) technology, wherein a long distance call of a client, typically a Personal Computer (PC) user, is carried over the Internet to a VoIP interface device in the vicinity of the called party. Such VoIP technology avoids the charges associated with placing a long distance call with a traditional long distance carrier. The interface device dials a local call on the PSTN to complete the connection for the VoIP client. Hence, the call travels partially over the Internet and partially over the PSTN as an analog call. A VoIP software application at the client device digitizes the user's voice and sends that as data messages across the Internet to the VoIP interface device. The VoIP interface device in turn converts the data messages to analog signals that are output onto the analog phone line. In the reverse direction, the VoIP interface device receives analog signals from the dialed phone and converts those analog signals to digital messages which it sends across the Internet to the VoIP client. The VoIP software at the client converts those digital messages to analog signals, which are output to the user via speakers.

In another aspect, the systems described herein relate to an Internet access technology currently being deployed that is referred to as DSL (Digital Subscriber Line) service. (The original acronym was ADSL, for Asynchronous Digital Subscriber Line.) Although there are some variations on the technology (now generically referred to as “xDSL”), it essentially involves an analog telephone line supplemented by a high frequency carrier signal superimposed on the telephone line by a pair of modems—one at the subscriber location, and one at the telephone company central office. The DSL carrier signal can carry high-speed data concurrently over the same phone line without interfering with the analog phone service. Other than being carried by the same physical wires, the phone line has no relationship to the DSL Internet service.

In another instance, the matter to be discussed relates to virtual phone service provided via cable-TV. Cable-TV service has been used to provide high-speed Internet access—the popular “cable modem” service. In addition, there are a number of current activities related to delivering alternative provider telephone service via the cable-TV distribution system. Similar to the Internet access service arrangement, the telephony service arrangement utilizes a “cable modem” to transmit and receive voice grade telephone calls. Other than being carried by the same physical cable, telephone service provided by cable-TV has no relationship to the cable modem Internet service.

A related matter is that of virtual phone service provided by the so-called fixed wireless arrangement, currently undergoing field trials in some areas, and by the newly introduced cellular telephone service with Internet access. Although these are substantially different services from a user perspective, the wireless infrastructure is much the same.

In each of these technologies, even though they provide both Internet and PSTN connectivity, the Internet aspect is separated from the telephony aspect.

The capabilities of the Internet and the PSTN, as just described, do not incorporate a means for storing and exchanging user profiles by communications systems and devices as desired by this patent application.

There are a group of standards and draft standards from the ITU (International Telecommunications Union) and the IETF (Internet Engineering Task Force) relating to Internet telephony (VoIP). The ITU standards include H.323 (the general standard), H.245 (signaling), H.248 (Internet Gateways), and T.120 (videophones), and collectively define how Internet phones should work, including such matters as call connection, determining the capabilities of the receiving phone, conferencing, transferring files and images, enabling shared whiteboards, audio and video codecs, supported transport protocols, etc. Competitive standards from the IETF include SIP (Session Initiation Protocol, RFC 3261), SDP (Session Description Protocol, RFC 2327), and the SIP draft standard “callerprefs” (for Caller Preferences, no RFC as of this writing).

The combination of SIP and “callerprefs” provides an arrangement for calling and called parties to influence the direction of a call. SIP operates on the basis of proxy servers, perhaps attached to a corporate LAN, which provide VoIP services for client PCs. A SIP user may have a primary SIP Internet address of the form sip.john@acme.com. An Internet call placed to that address will be directed to the SIP proxy server (perhaps sip@acme.com) which provides VoIP services for John. At the time of service establishment, John will register his electronic Contact addresses with his server. These addresses might include his office phone number, cell number, home phone number, email address, and so on. Each contact number may have attributes including: service (IP, voice mail, ISDN, pager, etc.); media (audio, video, text); duplex (half or full); mobility (fixed, mobile); priority (normal, urgent); description (“for emergency only”). He will assign a numerical weighting to each of these (a Q=quality number from 0 to 1), representing his preference for having calls directed to each of those Contacts. In the absence of caller preferences on how to direct the call, an incoming call setup request to John's proxy server will automatically route the call to John's Contact address having the highest numerical preference.

Through the companion draft standard “callerprefs”, SIP also provides the ability for a SIP caller to express preferences on how the call is to be routed to the callee. The call setup message (an INVITE message) may carry three fields of information instructing call processing servers on these preferences. (The three fields are: REQUEST DISPOSITION; ACCEPT CONTACT; REJECT CONTACT). The ACCEPT CONTACT and REJECT CONTACT fields may contain user preferences suggesting the type of communications the caller would accept or not accept. For example, the caller might specify to accept having the call directed to a voice mail system, but reject having the call directed to a pager or mobile phone. The SIP standards do not suggest how a caller might invoke these preferences, but presumably that could be through a screen display when the call is placed. It should be noted that this is done in the blind by the caller, since in the absence of advance knowledge, the caller would not know whether or not the called party has a cell phone or a pager, etc.

The called party's call handling proxy server processes the calling party's preferences contained in the call setup request (the INVITE) by mapping them against the called party's contact list and preferences (the Q number), to compute a list of acceptable alternatives for directing the call. The call is then passed on to the called party's CONTACT having the highest computed numerical value.

There are other arrangements for systems to exchange information in a fashion related to the topic of this patent application. There is an Internet industry organization (Versit) promoting the “v-card”, which is a text-based schema for exchanging “Electronic Business Card” information between users. The primary focus of the v-card is as an email attachment, although there are other Internet applications. Particularly, the SIP standard suggests the possibility of sending an INVITE message with MIME attachments (having CONTENT DISPOSITION=render so it will display on the receiver) for sending information such as a photo, logo, v-Card, etc. Using this arrangement in a SIP VoIP call, a caller's v-Card would pop up on the called party's screen as the phone started to ring.

A somewhat similar arrangement is provided by U.S. Pat. No. 5,999,599 Shaffer, et al., in which an audio file and/or an image file may accompany a call setup request across the PSTN, via SS7 or ISDN user-to-user messaging, for announcement or display to the called party as the phone begins to ring.

However, of the above technologies, none specify or support a method that enables a caller to dynamically influence the processing of a call by having available the called party's profile, nor are there means or methods to exchange text-based contact and profile information between devices as a part of a call setup procedure on the PSTN, as is specified in this patent application.

Because of these voids, there remains a need in the art for a method and means for storing and exchanging user and system profiles to enhance voice and multimedia communications on the PSTN and Internet, and to further promote the integration of the Internet with the PSTN.

### SUMMARY OF THE INVENTION

The present invention provides a method and means for communications systems and devices to store and exchange user profiles, thereby enhancing telecommunications and Internet voice and multimedia communications. Several co-pending patent applications of the same inventor provide for the integration of the Internet with the Public Switched Telephone Network (PSTN) in various aspects, including a method and means for enabling a calling device to create an Internet communication with another device simply by dialing its telephone number on the PSTN. One benefit of such integration is that traditional voice only telephone calls can be augmented or replaced with multimedia communications using Internet protocols and capabilities. Such multimedia communications may include: voice and other audio; graphics, images and other visual material; motion video; and synchronized audio and video transmitted together including TV video and videophone service. The data for these multimedia communications may be transmitted on the Internet as a result of the integration described therein, while, optionally, the voice portion of a multimedia communication may be transmitted over the PSTN for improved audio quality. The enhanced capabilities provided by the present invention further facilitate that integration by enabling a call dialed on the PSTN to provide for the exchange of user profile information with the associated data and messaging communications transpiring over either the PSTN or the Internet.

Co-pending patent applications describe an arrangement wherein an Internet communication is established by a user device dialing the telephone number of another system or device on the PSTN. In general terms, this is accomplished by the PSTN (central office switches, for example) obtaining the IP address of the calling or called device, and providing that address to the other device via a call management messaging system (such as SS7, the ISDN messaging capability, or the Internet). The messaging communications encompasses messages as are necessary to establish, tear down, transfer, and otherwise manage all aspects of call control for both PSTN and Internet aspects of the communication. Once one device has the IP address of the other, an Internet communication may commence. User devices particularly include display phones configured as Integrated Devices. As defined in the co-pending patent applications, an Integrated Device is capable of establishing an Internet communication with another Integrated Device by dialing its phone number on the PSTN. An Integrated Device has an Internet connection with an IP address, a telephony connection with a telephone number, and supports digital message communications to the PSTN such as ISDN for call management (signaling).

Messages incorporating stored profile data are exchanged between communications systems. Typically a stored profile exchange begins with one user device calling another by sending it a call setup request message. In one possible arrangement, stored profile information formatted as ISDN messaging data could be transmitted between calling and called devices via the SS7 network in the context of an enhanced SS7 call setup request message. In another possible arrangement, once the calling and called devices have been provided with the IP address of the other, stored profile information could be transmitted across the Internet between the two devices. Thus, in this environment, stored profile messages between calling and called systems may transit either the Internet or the PSTN. In another aspect of this invention user profile information messages are transmitted across any other medium such as a wireless arrangement, between communications systems and user devices operable with this invention.

There are a wide variety of communications systems and devices subject to the matter of this invention. These include: office telephone systems such as PBXs and Key Systems; adjunct devices such as automated attendant systems, Voice Mail Systems, automatic call distributor systems, and the like; facsimile machines; wireless communications devices such as a cellular phone having a display screen; terminal devices such as telephones having a display screen and Integrated Devices; and Internet communications devices such as Personal Computers (PC's) and servers.

Voice and multimedia communications systems store and exchange profiles enumerating communications-related information of the user. Stored profile information for the user of a communications system can include all the contact information an individual might wish other's to know, such as identification and other personal information, contact information, alternate person contact information, status or availability, and call or message routing, as suggested by the following: (i) electronic contact information: fax number, home phone number, office phone number, cell phone number, Voice Mail System number, pager number and instruction sequence, e-mail ID, etc.; (ii) supplemental contact information: street and postal addresses; (iii) business and other affiliations, business logo, and so on; (iv) alternate person contact information: secretary, supervisor, backup person—this listing might include job descriptions and recommendations of what kinds of calls might be handled by each of the listed parties (e.g., Bob Dylan is my primary backup while I am out, but if he is unavailable you can speak to my supervisor, Joni Mitchell); (v) other personal information such as a photo; (vi) status and availability: “I'll be in Hong Kong this week”; and (vii) call or message routing information: “If Calista Flockhart calls, transfer it to my cell phone”—“I'll accept calls from Carmen Elektra, but if Bob calls, send the call to Voice Mail”.

Without restrictions imposed by a user, another party accessing that user's stored profile gets a screen listing all of the user's contact numbers. However, a user's stored profile information may have privacy and access restrictions so that certain information elements will only be released to particular individuals or groups (my home number is only made available to friends, family members have access to all my contact information, co-workers have access to my business numbers, cell phone, and pager, and so on). Individuals and groups are identified by Caller-ID, Call Waiting-ID, or by their stored profile information, which the communications system matches against rules supplied by the user for restrictions and access rights. For example, a user might create only two groups, one group being family and friends, and the other being anyone else. The user creates a listing of family and friends by name, phone number, or other identifier. The user administers their list of contact numbers, allowing access by the group “family and friends” to all contact numbers, and allowing anyone else access only to the user's business phone number. On every incoming call or stored profile information request, the communications system compares the name, phone number, or other identifiers of the calling party, based on their stored profiles, to determine if they are a member of the group “family and friends”. If the caller is a member of that group, they are provided all of the user's contact numbers; if they are not a member, they are only given the user's business telephone number.

Stored profile data is arranged to be transmitted to the other party, and is formatted for presentation on the other party's display screen by incorporating associated presentation information into the messages. While other technologies, including technologies yet to be defined, may be as suitable or more suitable, the current Internet technologies of HTML (HyperText Markup Language) and http (hypertext transfer protocol) are suitable as languages for expressing presentation information and generating responses to selectable presentation elements. Some of the features of this patent application are of most benefit when the users of such systems can interact with and control other communications systems via screen-based user prompts, as described in co-pending patent application entitled “Interactive Device Control System For Integrating The Internet With The Public Switched Telephone Network”. In this arrangement, the communications system offers a remote user control over selected functions by the presentation of screen buttons or similar selectable response elements. The user's system and the displayed response elements are arranged so that the user can choose a selectable option with any human-machine interactive means such as by touch entry on the screen, pressing pre-configured physical or dynamically programmable “soft keys”, by a voice response, by the use of keys on a keyboard, or pressing dial pad buttons. The HTML protocol specifies a “hyperlink” capability by which these unique response messages could be encoded in the screen presentation information and associated with screen elements such as buttons, and the http protocol specifies a mechanism by which user activation of a hyperlink sends the associated unique response message to the destination device or system. In essence, the called device sends a web page to the caller. In that respect, the presentation aspect of this arrangement could be consider as a client “browser” in the user's phone that communicates with a “server” in the remote communications device.

In one variation of this invention, user profile information is sent to and exchanged with corresponding systems in the call setup process, particularly in the circumstance of a failed call setup attempt due to the called party not answering. In this circumstance, the called party's profile information is transmitted to the caller in the fashion of a web page with control buttons, enabling the caller to activate a control button to alter the routing of the call such as by transferring the call to the called party's cell phone. In other variations of this invention, the stored profile information can be sent from one system to another on demand, either initiated by the user of the sending device, or as a response to a request for stored profile information from another user or device.

User profile information enables a sophisticated call management process in which both the caller and the called party have control over how a call is to be routed. The present invention includes communications devices and systems that provide interactivity between the calling and called systems that enables the caller to manage the flow of the call with information provided by the called party, and within any constraints that may have been previously established by the called party. Subject to the privacy and access restriction rules, a callee's profile may be transmitted in presentation form to the caller for presentation on the caller's system. Delivery of the callee's profile to the caller may be occasioned by the callee not answering, by the caller initiating an Information call to the callee, rather than a standard phone call, or by manual activation by the callee. Each contact element presented on the caller's display screen may be associated with a control button to activate a particular action, such as initiating a call to the callee's cell phone or transferring to the callee's VMS, sending an email to the callee, or even sending a letter to the callee. Caller controlled Call Routing is enabled by the displayed control buttons. Pressing a button activates the associated call management function, such as transferring the call to the called party's cell phone. By this means, both the calling and called party's preferences are accommodated in the handling of the call. The called party's preferences are implemented in the Privacy and Restriction rules that determine which callers have access to aspects of the called party's profile information. The calling party exerts their preference by choosing a control button.

In contrast with SIP, the present invention provides dynamic interactivity between the calling and called systems that enables the caller to manage the flow of the call with information provided by the called party, and within constraints that may have been previously established by the called party. Recall that in the SIP environment, the caller expresses their preferences in the blind, before they dial the call, and thus the caller does not have the opportunity to select their preference of the actual contact numbers and contact methods that might be available for the called party. In the present invention, if the called party does not answer, the called system automatically selects the callee's profile elements available to caller based on the privacy and access restriction rules, and automatically sends that information to the caller. Optionally, another system, such as the called party's VMS, performs these functions on behalf of the called party's system. In this arrangement, when a call is forwarded to VMS due to busy/no answer on the called line, the VMS automatically sends the called party's profile to the caller.

Furthermore, and fundamentally, SIP capabilities are only available in a VoIP environment utilizing the SIP call management process, and are not available in the environment of the present invention in which Internet communications are established and managed by the PSTN. As mentioned elsewhere, co-pending patent applications describe an arrangement wherein an Internet communication is established by one device dialing the telephone number of another device on the PSTN; in this arrangement, the PSTN, utilizing appropriate messages sent via SS7, ISDN, or the Internet, establishes either an Internet connection, a PSTN connection, or both for the completion of the call. Subsequent to call establishment, the PSTN maintains control and management of calls, including those calls that result in an Internet communication.

A user could arrange to have profile information, data, images, etc., of any nature combined into a canned message for delivery to the other party—an Electronic Business Card (E-Card) or v-Card are examples of such information. A selection of stored profile information could be combined into an E-Card, comprising such information as a user's name, photo, title, business affiliation, business logo, address, phone number and other contact numbers, and so on. The E-Card incorporates presentation formatting information (like a mini-web page), and could include control buttons enabling the receiver to initiate calls or other actions based on the E-Card information.

An E-Card can be sent by the calling system to the called system during call setup for presentation on the called party's system before they have answered the call. In this arrangement, an E-Card acts like an “enhanced Caller-ID”, providing the called party with expanded information about the caller, perhaps including the caller's photo and other information that the caller would like the called party to know. The E-Card data could be transmitted either on the PSTN via SS7 or ISDN messaging in conjunction with call setup messages, or could be transmitted across the Internet once an Internet communication is established between the calling and called devices (which could still be before the called party answers). Preferably, E-Card text-based data is sent as an enhanced PSTN call setup message, and is associated with the call in the same fashion that Caller-ID is associated with a call. Whereas Caller-ID data is maintained in the PSTN as an element of a subscriber's record, and is provided by the PSTN to the called party on call setup, E-Card data preferentially is maintained by the user to allow for easy changes and multiple E-Cards with variations of a user's profile information. In this preferred arrangement, the E-Card is transmitted from the user device to the PSTN as part of a call setup request message, and then forwarded by the PSTN to the called device in conjunction with the PSTN call setup process.

In a similar vein to the argument, expressed previously, this E-Card application is differentiated from possible similar SIP capabilities which are only available in a VoIP environment utilizing the SIP call management process (e.g., a v-Card sent with a SIP INVITE call setup message), and are not available in the environment of the present invention in which Internet communications are established and managed by the PSTN.

In addition, the E-Card of either the called or calling party could be passed to the other party on demand after call setup, by the action of the users on appropriately arranged user phone devices. For example, perhaps a user device is configured with a screen button to “Send E-Card”, and another screen button to “Get E-Card”. Actuating one of these screen buttons will either cause the user device to send a message to the other party containing the user's E-Card, or will send a message to the other party requesting that they send their E-Card—the associated response to such a request could either be automatic or manual. For security purposes, systems could be arranged such that personal information such as an Electronic Business Card will not be sent without the user's authorization—thus a manual response might be the preferred implementation.

A user display phone could be arranged to save the other party's E-Card, either automatically or upon a user action. The E-Card, along with any associated presentation formatting and device control buttons, is saved to the user's system in much the same fashion that Caller-ID devices store calling telephone numbers, or could be saved in a user application such as an electronic phone book. Recalling the entry enables the user to call (or email, fax, etc.) the party using the provided control buttons. Similarly, a VMS answering a call for a called party may obtain and save the caller's E-Card along with any message the caller may leave. To facilitate this process, the called party's phone forwards the calling party's E-Card to the VMS, along with forwarding the call. In this fashion, the calling party's E-Card is associated with a call, and is transferred from phone to phone along with the call.

This invention also provides the ability to create multiple stored user profiles for a phone or system, wherein multiple users can create and use their own profile for environments such as a share home phone. Similarly, a person can have more than one stored profile and be able to select which stored profile is to be used by the system as he sees fit. For example, a person who is a businessman and also an executive of a charity may have a stored profile appropriate to each function.

A VMS system operating on user profile attributes relating to availability and call and message routing can provide custom announcements. Since the called party's VMS system receives the calling party's stored profile, or the simpler Caller-ID or Call Waiting-ID, it can be arranged to respond differently to various groups or individuals, as stated previously in relation to restricting access to certain contact numbers. For example, you might administer your system to give Britney Spears a special audible announcement message if she calls: “Hi Britney, I'm arriving in Hong Kong on Tuesday morning. Try to meet me for dinner.” Custom announcements can be implemented with voice, visual, or multimedia responses to caller, including control buttons: e.g., a displayed text message with control buttons—“Britney, click here to try my cell phone. If I don't answer, click here to ring my hotel.” This feature avoids the need for the caller to write down phone numbers, instructions, directions, etc.

In another embodiment, this invention extends the features and benefits of stored profiles by making the user's personal aspects of those profiles portable between systems, services, and devices. Those aspects of stored profiles relating to a user's identity, contact numbers, status, and so on, can be transferred to or maintained on a portable system such as a smart card or a Bluetooth enabled wireless device such as a Personal Digital Assistant or cell phone. Phones and phone systems providing stored profile capability may also have the capability to receive information from such a portable device, and to use the stored profile from the portable device as the active profile for the duration of the user's transaction. A person can use any phone so equipped, for example pay phones at public places like airports and hotels, and receive all the benefits of stored profiles as if they are calling from their own phone. For example, a person at an airport using an enabled phone could call someone with a compatible system and have his or her E-Card sent to the called party during the call setup. If the called party had left a personalized announcement message for the caller, since the caller is identified by name, the messaging system can deliver the announcement message. And if the called party enabled an individualized call routing for this person, that capability could be activated as well.

Consider this example scenario. Bill is also in Hong Kong, and expects to rendezvous there with Christy Brinkley. Bill rented a GSM cell phone in Hong Kong, but would prefer that only a select few people have access to him through that number. Anticipating that she will try to call him, Bill leaves a personalized message for Christy on his main number telling her his schedule, and authorizing his phone system to offer to connect her to his GSM cell phone. When Christy calls from the airport using a stored profiles-enabled phone, she will hear her personalized message from Bill and may activate a control on the airport phone that will connect her directly to his GSM cell phone. If Bill were not available at that time, Christy could leave a message for him, accompanied by her E-Card.

SIP vendors have demonstrated a portable version of the SIP caller preferences. However, as presented previously in this document, there are distinctive differences between the SIP caller preferences (ACCEPT CONTACT, and REJECT CONTACT), and the profile information and functionality introduced in this patent application.

As an alternative to a user carrying a device such as a Smart Card containing the user's stored profile, the user's stored profile information, or a copy of that information, could be stored in the network. For example, a telephone service provider might offer network-based stored profiles as part of a more general service offering. In using any enabled communications device associated with the service provider's network, a user can become associated with their stored profile and use that information in the conduct of the current session. The operation would be the same as in the Christy Brinkley example above, except that Christy simply uses an available display phone at the airport and identifies herself properly to access her stored profiles.

This invention then, provides for a method and means for voice and multimedia communications systems and users to maintain and exchange communications related information, enabling both calling and called parties to influence control over a call, and enabling users to exchange contact information such as E-Cards as a part of call setup, operating like an enhanced Caller-ID. The stored profiles capability extends to communications systems on both the PSTN and the Internet, thus further promoting the integration of the Internet with the PSTN.

### BRIEF DESCRIPTION OF THE DRAWINGS

The invention will be more fully understood when reference is had to the following detailed description of the preferred embodiment of the invention and the accompanying drawings, in which:

FIG. 1 is a schematic illustration of the present invention showing an environment of user devices and systems having both Internet and PSTN connectivity.

### DETAILED DESCRIPTION OF THE INVENTION

Described herein is a stored profile system for storing and exchanging user and system profiles by communications devices, systems, and services both on the PSTN and on the Internet. The purpose of the stored profile exchanges is to provide an arrangement enhancing communications between users and systems over that which is available with conventional systems, while promoting the integration of the Internet with the PSTN.

The present invention provides a method and means for storing and exchanging communications system and user profile information to enhance voice and multimedia communications both on the PSTN and on the Internet.

Co-pending patent applications provide a method and means for integrating the Internet with the Public Switched Telephone Network (PSTN); more specifically, they enable a calling device to establish an Internet communication with a called device simply by dialing its telephone number. One benefit of such integration is that traditional voice-only telephone calls can be augmented or replaced with multimedia communications using Internet protocols and capabilities. Such multimedia communications may include: voice and other audio; graphics, images and other visual material; motion video; and synchronized audio and video transmitted together including TV video and videophone service. The data for these multimedia communications may be transmitted on the Internet as a result of the integration described therein.

The co-pending patent applications describe various aspects of this integration; the enhanced capabilities provided by the present invention facilitate that integration. The following provides an overview of the co-pending patent applications.

Co-pending patent application entitled “Integrated Device For Integrating The Internet With The Public Switched Telephone Network”, Ser. No. 60/301,756, Docket No. 0054-3, describes “Integrated Devices”, for integrating the Internet with the PSTN, which have an Internet connection with an associated IP address, a PSTN connection with an associated telephone number, and a digital messaging connection to the PSTN for conveying call management messages to include messages containing telephone numbers and IP addresses.

Co-pending application entitled “Integrating the Internet with the Public Switched Telephone Network”, Ser. No. 60/301,757, Docket No. 0054-4, describes an enhanced communications environment in which a telephone call placed to an Integrated Device creates end-to-end communications over the Internet rather than over the PSTN.

There exists a class of devices, such as those for Voice over IP, DSL, cable TV, fixed wireless, Internet capable wireless cellular, and similar distribution systems, which provide Internet and telephony services to client devices, such as phones and PCs, by providing an interface to the telephone company central office switching system. Co-pending application entitled “Telephone Central Office Switch Interface With Messaging Channel For Integrating The PSTN With The Internet”, Ser. No. 60/301,758, Attorney Docket No. 0054-5, discloses a method and means for providing specific messaging capabilities between a telephone central office switching system and this class of interface device, enabling the integration of the Internet with the PSTN. The communications link carries call setup, telephone number, and IP address messages to and from the switching system and to and from the client devices of the interface device.

Co-pending patent application entitled “Telephone Switching System For Integrating The Internet With The Public Switched Telephone Network”, Ser. No. 60/306,294, Attorney Docket No. 0054-7, discloses a method and means for a telephone central office switching system to enable a calling device to establish an Internet communication with a called device by dialing its telephone number.

Co-pending patent application entitled “Integrated Telephone Central Office Systems For Integrating The Internet With The Public Switched Telephone Network”, Ser. No. 60/306,293, Attorney Docket No. 0054-8, discloses an integrated assembly of telephone central office switching system integrated interface devices, comprising telephone central office switching systems, and switching system interface devices such as those for providing DSL service, Voice over IP (VoIP) service, cable modem service, fixed wireless service, and Internet capable cellular wireless service. The integrated telephone central office systems therein described offers efficiencies and economies further benefiting the integration of the Internet with the PSTN.

Co-pending patent application entitled “Call Management Messaging System For Integrating The Internet With The Public Switched Telephone Network”, Ser. No. 60/311,401, Attorney Docket No. 0054-9, discloses a messaging system for communicating call management messages among communications devices connected to the Internet and to the PSTN. Call management messages include call setup request messages, call acceptance messages, call rejection messages, call forwarding messages and the like. The call management messaging system operates seamlessly across both the Internet and the PSTN, thus providing further integration of those two networks.

Co-pending patent application entitled “Interactive Device Control System For Integrating The Internet With The Public Switched Telephone Network”, Ser. No. 60/317,055, Attorney Docket No. 0054-11, discloses a system for the PSTN and the Internet in which a communications system offers the user of a device such as a screen phone the ability to control or influence functions of the communications system by presenting the user with a displayed menu of options. The menu of options is sent to the user's device by the communications system via a messaging system. Selection of an option by the user returns a response message to the communications system via the messaging system. Upon receipt of the response message, the communications system actuates the function associated with the user-selected option. The interactive device control system operates seamlessly across both the Internet and the PSTN, thus providing further integration of those two networks.

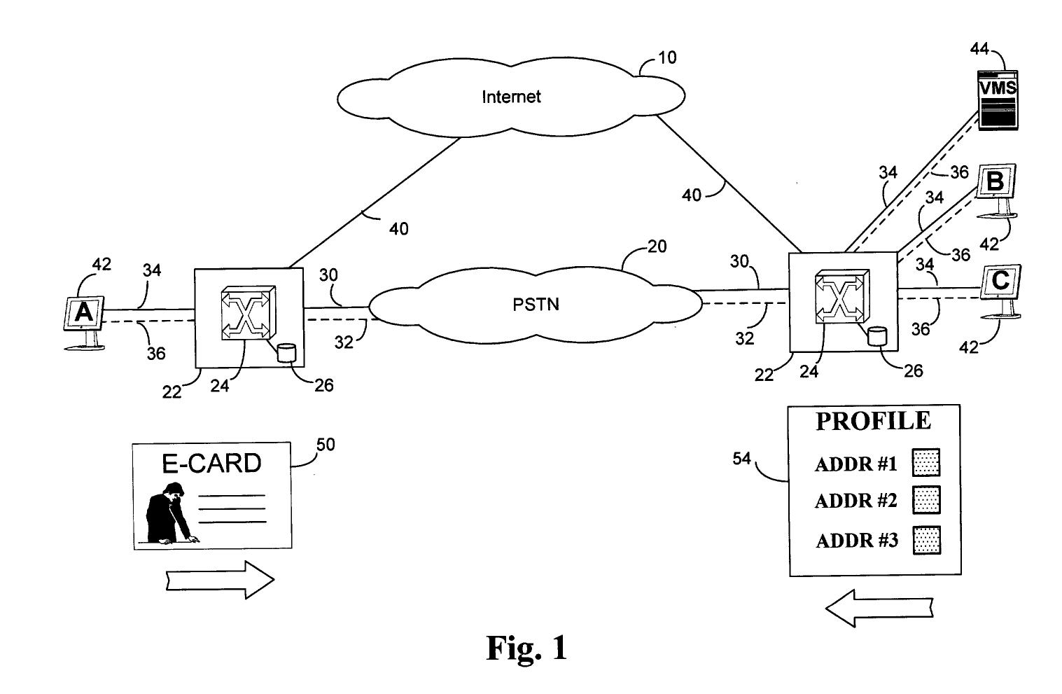

FIG. 1 is a schematic illustration of the present invention showing an environment of user devices and systems having both Internet and PSTN connectivity. Referring to FIG. 1, the Internet is shown stylistically as 10 and the PSTN as 20. The PSTN is comprised of telco Central Offices 22 incorporating switching systems 24, and subscriber records database 26. Central Offices 22 and their component systems are connected to each other and to the PSTN in general via multiplexed trunks 30 and SS7 messaging network 32, and have high speed access links 40 to the Internet. Access links 40 are suitable for conveying packetized voice, videophone, images and similar data, in addition to packetized messaging or signaling data. User display phones 42, labeled A, B, and C, and Voice Mail System (VMS) 44 are connected to their respective telco Central Offices via multiplexed communications links having voice and multimedia communications connectivity 34, and messaging system connectivity 32 to carry messaging and signaling data such as ISDN messages to and from the PSTN. The multiplexed communications links are suitable for conveying packetized voice, videophone, images and similar data, in addition to packetized messaging or signaling data, such as may be provided by DSL or cable-TV access arrangements. User device A, being the caller in the following examples, maintains an E-Card 50, while user device B stores user B's profile 54; optionally, the associated VMS also stores user B's profile 54. Although not shown, devices storing B's profile also store any privacy and access restriction rules on that data as established by user B.

The operation of this arrangement is presented in the following example. User A dials the telephone number of user B, causing user device A to send a call setup request message and associated E-Card 50 to its serving Central Office via messaging link 36. User A may have multiple E-Cards for different purposes, and may have selected a particular E-Card for this call. As described in the co-pending patent applications, call setup of an Internet communications is achieved by elements of the PSTN, such as the serving Central Offices for the calling or called parties, obtaining the IP address of either or both of the calling and called devices and providing that IP address to the other via a digital message system. The IP addresses may be obtained from subscriber records system 26. The data paths for these messages encompass SS7 links 32 between PSTN systems, and messaging links 36 to the user devices and systems. User device B receives the multimedia call setup request with the accompanying E-Card, and presents the E-Card on its display screen as the call is announced (i.e., ringing). User phone B may be configured to store the E-Card automatically, whether or not user B answers the call, in the same fashion that Caller-ID devices automatically store the calling numbers for all incoming calls. Optionally, user phone B may be configured to allow user B upon answering the call to manually activate the storage of the E-Card. An E-Card can also be sent on demand. If user A and B establish a conversation, user A may ask user B to send their E-Card, which can be accomplished by user B activating a software control. In this circumstance the E-Card is sent across the Internet as a multimedia element, in a similar fashion to sending a web page.

In one variation of this example, user B answers the call from A. Since an Internet multimedia call was enabled by the PSTN, users A and B have established a communication across the Internet; the data for this multimedia call traverses voice and multimedia communications connectivity 34, and is routed by an element (not shown) of the associated Central Offices across Internet access links 40, and thence across the Internet. User B initiates a transfer of the call to user C, causing user device B to send a call transfer request message and the associated E-Card 50 of the calling party to its serving Central Office via messaging link 36. Following a process similar to the initial multimedia call setup, the PSTN elements tear down the call between A and B, and establish a call between A and C. In the process, the E-Card for user A is delivered to user phone C as the incoming call starts to ring.

In another variation of this example, the call from A to B is not answered. Assume for this variation that user device B is not associated with VMS 44. As in the previous example, user phone B receives the E-Card from A; in the case where user phone B is busy, the PSTN may deliver the E-Card to a busy phone in the fashion of delivering Call Waiting-ID to a busy phone. In the circumstance of B not answering, user phone B compiles user B's profile elements that are available to caller A based on the privacy and access restriction rules established by user B, and sends the resulting profile 54 in a message to caller A for display on caller A's screen. Profile 54 includes available contact methods to reach user B, such as a cell phone number, a backup person (perhaps user C), and so on. Each listed contact has an associated control button that can be activated by user A. If user A activated the control button to transfer the call to user C, a response message would be sent from user phone A to user phone B, causing user phone B to transfer the call to user C.

In yet another variation of this example, assume that device B is associated with VMS 44, and unanswered calls at B are automatically forwarded to VMS. As in the case of B transferring the call to C, when the Central Office switch forwards a call for B to VMS, it also forwards the calling party's E-Card along with the call. The VMS now has the E-Card from A, and may store the E-Card along with any message recorded by user A. Additionally, the VMS, being in possession of user B's profile information, compiles user B's profile elements that are available to caller A based on the privacy and access restriction rules established by user B, and sends the resulting profile 54 in a message to caller A for display on caller A's screen. As before, user A may then activate one of the control buttons to further route the call, rather than leaving a message.

In the above circumstances, user phones B and C, and VMS 44 are illustrated as connecting directly to the telco Central Office, and therefore call setup and call transfer activities, including those associated with the processing of an E-Card, are indicated as being performed by the CO. However, in other circumstances, the user phones and VMS may be working behind a secondary system, such as a PBX. In those circumstances, the PBX performs the functions stated above, acting as a surrogate for the PSTN.

As just described, the Internet and the PSTN comprise a seamless whole, capable of functioning as a single, integrated system.

Having thus described the invention in rather full detail, it will be understood that such detail need not be strictly adhered to, but that further changes and modifications may suggest themselves to one skilled in the art falling within the scope of the present invention as defined by the subjoined claims.

What is claimed is:

1. A system for multimedia communications, comprising a user system for answering calls, said user system having a compilation of user communications-related information including user telephone numbers, and being operative in response to an unanswered call to the user, to send said user information to the caller for presentation on a display screen.

2. A system for multimedia communications as recited in claim 1, in which said system is a user phone.

3. A system for multimedia communications as recited in claim 1, in which said system is a Voice Mail System.

4. A system for multimedia communications as recited in claim 1, in which the user information further comprises formatting information for presentation on a display screen.

5. A system for multimedia communications as recited in claim 1, in which the call to the user is placed on the PSTN.

6. A system for multimedia communications as recited in claim 1, in which elements of the user information, including a telephone number, are restricted from distribution to specified callers, and in which the system does not send the restricted information elements to such a specified caller, callers being identified by Caller-ID or other identifying information provided to the called system.

7. A system for multimedia communications as recited in claim 1, in which the caller may actuate displayed controls associated with the presented user information items, and by doing so send a response message to the called system, whereupon the system transfers or forwards the call to a designated telephone number associated with the actuated control.

8. A system for multimedia communications as recited in claim 1, wherein the system acting on behalf of the user is a PSTN component such as a Central Office switching system.

9. A stored profile system for voice and multimedia communications for storing and exchanging user communications information, comprising:
(a) a communications system including a display phone having a record of user information, comprising an Electronic Business Card (E-Card);
(b) the record of user information being arranged for presentation to a called user on a display screen;
(c) the record of user information being transmitted to a system in the call establishment process; and
(d) the record of user information being presented to the called user.

10. A stored profile system as recited in claim 9, wherein the record of user information is transmitted to the called system by the PSTN.

11. A stored profile system as recited in claim 9, wherein the record of user information is associated with the call, and upon the transfer or forwarding of the call, the record of user information is also transferred or forwarded to the target telephone number, for presentation on the target system.

12. A stored profile system as recited in claim 9, wherein the transferring or forwarding of the record of user information is performed by the PSTN.

13. A stored profile system as recited in claim 9, wherein the transferring or forwarding of the record of user information is performed by a surrogate system for the PSTN, comprising an office telephone system having the form of a PBX.

14. A stored profile system as recited in claim 9, wherein the record of user information is stored by the called system.

15. A stored profile system as recited in claim 9, wherein the record of user information comprises text-based data.

16. A stored profile system as recited in claim 9, wherein a communications system or a user device comprising a display phone maintains multiple records of user information, and the record to be sent in association with a call is selectable by the user.

17. A stored profile system as recited in claim 9, wherein the record of user communications information is maintained in a portable device arranged to dynamically convey such information to a communications system, and the communications system is arranged to transmit the received record to a called system in the call establishment process.

18. A stored profile system as recited in claim 9, wherein the record of user communications information is maintained in a PSTN network system arranged to dynamically convey such information to a communications system, and the communications system is arranged to transmit the received record to a called device in the call establishment process.

19. A stored profile system for voice and multimedia communications for storing and exchanging user communications information, comprising:
(a) a user device comprising a display phone having a record of user information in the form of an Electronic Business Card (E-Card);
(b) the record of user information being arranged for presentation on a display screen;
(c) the record of user information being transmitted from the user device to a corresponding device on a call, by an action of the user which comprises activating a software control on a display screen; and
(d) the record of user information being presented to the user of the corresponding device.

20. A method of operation of a stored profile system for voice and multimedia communications, wherein a communications device or system maintains a compilation of user communications-related information, such as user telephone numbers, comprising the steps of:
(a) sending a call setup request message to a communications system by a calling user device comprising a display phone, the call setup request message being sent on the Public Switched Telephone Network (PSTN) via a messaging system such as an SS7 network or ISDN messaging capability of the PSTN;
(b) receiving the call setup request message by the called system;
(c) sending the calling device a compilation of communications-related information of the called user under circumstances where the user of the called system does not answer the call;
(d) receiving the called user information by the calling device; and
(e) presenting the called user information on the display screen of the calling device for the benefit of the calling user.

21. A method of operation of a stored profile system as recited in claim 20 wherein the step of sending the called user communications information to the calling device is accomplished on the PSTN.

22. A method of operation of a stored profile system as recited in claim 20 wherein the step of sending the called user communications information to the calling device is accomplished on the Internet.

23. A method of operation of a stored profile system as recited in claim 20, wherein the called user communications information incorporates formatting information for presentation on a display screen such that the calling user can actuate a displayed control item and wherein the actuated control item sends a response message to the called device indicating the calling user's preference for the disposition of the call, optionally by transferring the call to a designated telephone number, further comprising the steps of:
(a) actuating a displayed control item by the calling user;
(b) sending a response message associated with the actuated control item to the called device by the calling user device;
(c) receiving the response message by the called device; and
(d) executing the calling user's preference by the called device.

24. A method of operation of a stored profile system for voice and multimedia communications for storing and exchanging user communications information wherein a user device comprising a display phone maintains a record of user information, in the form of an Electronic Business Card (E-Card), which is formatted suitably for presentation on a user device display screen, comprising the steps of:
(a) transmitting the record of calling user information to the Public Switched Telephone Network (PSTN) by the user device in association with a call setup request to a called user device;
(b) sending the record of calling user information by the PSTN to the called user device in association with call establishment;
(c) presenting the record of calling user information on a display screen of the called user device;
(d) receiving the record of calling user information by the PSTN in association with a request from the called user device to transfer the call to a transferee user device;
(e) sending the record of calling user information by the PSTN to the transferee user device in association with call establishment to the transferee user device; and
(f) presenting the record of calling user information on a display screen of the transferee user device.
